(19) United States
(12) Patent Application Publication
(10) Pub. No.: US 2015/0130585 A1
(43) Pub. Date: May 14, 2015

(54) Fuse Element for Protection Device and Circuit Protection Device Including the Same

(71) Applicant: NEC SCHOTT Components Corporation, Koka-shi, Shiga (JP)

(72) Inventors: Shintaro Nakajima, Koka-shi (JP); Toru Fujita, Koka-shi (JP); Noriyuki Maeda, Koka-shi (JP)

(21) Appl. No.: 14/400,419

(22) PCT Filed: Apr. 24, 2013
(86) PCT No.: PCT/JP2013/061985

§ 371 Date: Nov. 11, 2014

(30) Foreign Application Priority Data
May 17, 2012 (JP) 2012-113369

(51) Int. Cl. H01H 37/32; H01H 37/04; H01H 37/64; H01H 69/02

(52) U.S. Cl. CPC H01H 37/32; H01H 69/02; H01H 37/04; H01H 37/64; H01H 2037/046
USPC 337/413; 29/623

(57) ABSTRACT

A fuse element (10) for a protection device has a base member (11) and a covering member (12) coating at least part of a surface of the base member (11), and is heated to a predetermined heating temperature to be bonded to the protection device. The base member (11) is made of a first fusible metal having a melting point higher than the heating temperature. The covering member (12) is made of a second fusible metal having a melting point lower than the heating temperature.

### TECHNICAL FIELD

The present invention relates to a fuse element for a protection device and a circuit protection device for electric/electronic equipment including the fuse element.

### BACKGROUND ART

In recent years, with the rapid popularization of small electronic equipment such as mobile devices, a protection device used to be mounted on a protection circuit for a power supply to be equipped is smaller and thinner. For example, for a protection circuit for a secondary battery package, a chip protection device for a surface mount device (SMD) is suitably used. Such chip protection devices include a one-shot operation protection device that detects excessive heat generation caused by an overcurrent in a protected device or responds to abnormal overheat of ambient temperature to operate a fuse under predetermined conditions for interrupting an electrical circuit. When a protection circuit senses a malfunction occurring in an instrument, the protection device can cause a resistive element to generate heat by a signal current in order to ensure safety of the instrument, and fuse a fuse element made of a fusible alloy material with the generated heat to interrupt the circuit or fuse the fuse element with an overcurrent to interrupt the circuit. For example, Japanese Patent Laying-Open Nos. 2008-112735 (PTD 1) and 2011-034755 (PTD 2) each disclose a protection device in which a resistive element generating heat in the case of a malfunction is provided on an insulating substrate such as a ceramics substrate and a protection device including this protection device for preventing a firing accident resulting from performance degradation caused by dendrite generated at the surface of an electrode in an overcharge mode of a Li-ion secondary battery.

Conventionally, a fusible alloy material constituting the fuse element of the above-described chip protection device is attached by bonding means such as laser welding to a pattern electrode formed on an insulating substrate such as a ceramics substrate. Laser welding is a technique suited to reliably bond a single fuse element to a pattern electrode, but requires an expensive laser welder, and a plurality of fuse elements cannot be bonded collectively because operation is performed while locally irradiating each bonding position with laser. It takes an operation time, and it is not necessarily a method with high production efficiency. Moreover, particularly in the case of bonding a planar fuse element to a pattern electrode on an insulating substrate, it is necessary to emit laser on the peripheral part of the fuse element in a pinpointed manner such that the whole fuse element will not be melted by laser radiation heat. It is difficult to use, for bonding, a pattern electrode if any at the central portion of the fuse element plate. Therefore, the entire contact surface between the fuse element and the pattern electrode cannot be used as a bonded surface, which is not recognized as optimum in terms of electric resistance and bonding strength.

Furthermore, in the case of using a thinner fuse element with the progress in reduction in size and thickness of a bonded component, such as a fuse element for a protection device and a substrate including a substrate electrode, a disadvantage arises in that the fuse element after welding is deformed by overheat with laser heat and a laser radiated part excessively swells to be locally thickened, resulting in bad appearance of element attachment. Accordingly, when covering the fuse element on the substrate with a cap-like cover member in a post process, the cap-like cover member cannot be attached horizontally to the insulating substrate or is displaced from a predetermined attachment position if the fuse element has been greatly deformed, which interferes with the operation of mounting the cover member. This unpreferably results in assembly failure and the like.

### CITATION LIST

### Patent Document

### PTD 1: Japanese Patent Laying-Open No. 2008-112735

### PTD 2: Japanese Patent Laying-Open No. 2011-034755

### SUMMARY OF INVENTION

### Technical Problem

Therefore, the present invention has been proposed to solve the above-described problems, and has an object to provide a fuse element for a protection device that can be improved in production efficiency and has favorable operating characteristic, as well as a circuit protection device for electric/electronic device including the fuse element.

### Solution to Problem

The present invention was made to solve the above-described problems, and includes the following:

[1] A fuse element for a protection device having a base member and a covering member covering at least part of a surface of the base member and being heated to a predetermined heating temperature to be bonded to the protection device, the base member being made of a first fusible metal having a melting point higher than the heating temperature, the covering member being made of a second fusible metal having a melting point lower than the heating temperature.

[2] The fuse element for a protection device described in [1], wherein the heating temperature is more than or equal to 183° C. and less than 280° C.

[3] The fuse element for a protection device described in [1] or [2], wherein a contact surface coming into contact with the protection device during the bonding contains flux for bonding.

[4] The fuse element for a protection device described in any one of [1] to [3], wherein the first fusible metal is one of a 20Sn-80Au alloy, a 55Sn-45Sb alloy, and a Pb—Sn alloy containing more than or equal to 80 mass % of Pb.

[5] The fuse element for a protection device described in any one of [1] to [4], wherein the second fusible metal is one of a Sn—Ag alloy, a Sn—Bi alloy, a Sn—Cu alloy, a Sn—Zn alloy, a Sn—Sb alloy, a Sn—Ag—Bi alloy, a Sn—Ag—Cu alloy, a Sn—Ag—In alloy, a Sn—Zn—Al alloy, a Sn—Zn—Bi alloy, and an alloy further containing at least one metallic element of Au, Ni, Ge, and Ga in addition to these alloys.

[6] The fuse element for a protection device described in any one of [1] to [5] is one of a plate-like member in which the covering member has a thickness of more than or equal to 1% and less than or equal to 20% of the thickness of the plate-like member and a rod-like member in which the covering member has a thickness of more than or equal to 1% and less than or equal to 20% of a diameter of the rod-like member.

[7] A circuit protection device including an insulating substrate, a pattern electrode provided on a surface of the insulating substrate, and a fuse element heated to a predetermined heating temperature to be bonded to the pattern electrode and is electrically connected to the pattern electrode, the fuse element having a base member and a covering member covering at least part of a surface of the base member, the base member being made of a first fusible metal having a melting point higher than the heating temperature, the covering member being made of a second fusible metal having a melting point lower than the heating temperature, the heating temperature is more than or equal to 183° C. and less than 280° C.

[8] The circuit protection device described in [7], further including a heating resistor provided on the insulating substrate.

[9] The circuit protection device described in [7] or [8], wherein the first fusible metal is one of a 20Sn-80Au alloy, a 55Sn-45Sb alloy, and a Pb—Sn alloy containing more than or equal to 80 mass % of Pb.

[10] The circuit protection device described in any one of [7] to [9], wherein the second fusible metal is one of a Sn—Ag alloy, a Sn—Bi alloy, a Sn—Cu alloy, a Sn—Zn alloy, a Sn—Sb alloy, a Sn—Ag—Bi alloy, a Sn—Ag—Cu alloy, a Sn—Ag—In alloy, a Sn—Zn—Al alloy, a Sn—Zn—Bi alloy, and an alloy further containing at least one metallic element of Au, Ni, Ge, and Ga in addition to these alloys.

[11] The circuit protection device described in any one of [7] to [10], wherein the fuse element before being bonded to the pattern electrode is one of a plate-like member in which the covering member has a thickness of more than or equal to 1% and less than or equal to 20% of the thickness of the plate-like member and a rod-like member in which the covering member has a thickness of more than or equal to 1% and less than or equal to 20% of a diameter of the rod-like member.

[12] A method for manufacturing a circuit protection device, including a preparation step of preparing an insulating substrate with a pattern electrode provided on a surface as well as a fuse element having a base member and a covering member covering at least part of a surface of the base member, a bonding step of heating the fuse element to a heating temperature of more than or equal to 183° C. and less than 280° C. with the covering member of the fuse element being in contact with the pattern electrode to bond and electrically connect the fuse element to the pattern electrode, a fusing flux applying step of applying fusing flux for operation to the fuse element, and a packaging step of covering the fuse element with a cap-like cover member for packaging, in the fuse element, the base member being made of a first fusible metal having a melting point higher than the heating temperature in the bonding step, and the covering member being made of a second fusible metal having a melting point lower than the heating temperature.

[13] The method for manufacturing a circuit protection device described in [12], having, prior to the bonding step, a bonding flux applying step of applying flux for bonding to the pattern electrode.

[14] The method for manufacturing a circuit protection device described in [12], wherein, in the bonding step, an activation step of removing oxide films on surfaces of the pattern electrode and the fuse element, thereby activating bonded surfaces.

[15] The method for manufacturing a circuit protection device described in [12], wherein the fuse element contains flux for bonding in a contact surface to be in contact with the pattern electrode.

### Advantageous Effects of Invention

Through use of the fuse element of the present invention, the fuse element and the protection device can be bonded by a simple method to increase production efficiency. Since the contact surfaces of the fuse element and the pattern electrode provided on the protection device can be easily bonded, the bonding area can be increased to reduce electric resistance while improving bonding strength.

### BRIEF DESCRIPTION OF DRAWINGS

FIG. 1 is a perspective view schematically showing a fuse element for a protection device of a first embodiment.

FIG. 2 is a perspective view schematically showing a fuse element for a protection device of a second embodiment.

FIG. 3 is a perspective view schematically showing a fuse element for a protection device of a third embodiment.

FIG. 4 is an exploded perspective view showing a structure of a circuit protection device of a fourth embodiment.

FIG. 5 shows a structure of a circuit protection device of a fifth embodiment, FIG. 5(a) showing a schematic view of an upper surface, FIG. 5(b) showing a longitudinal section and FIG. 5(c) showing a schematic view of a lower surface.

FIG. 6 shows a structure of a circuit protection device of a sixth embodiment, FIG. 6(a) showing a schematic view of an upper surface, FIG. 6(b) showing a longitudinal section and FIG. 6(c) showing a schematic view of a lower surface.

### DESCRIPTION OF EMBODIMENTS

[Fuse Element for Protection Device]

A fuse element of the present invention has a base member and a covering member covering at least part of the surface of the base member, and is heated to a predetermined heating temperature to be bonded to a protection device. The fuse element is not limited in shape, and is a plate-like member, a rod-like member or the like, for example. The covering member is provided to cover at least part of the surface of the base member, and may be provided to cover the entire surface. For example, a plate-like base member can be used, and a covering member can be provided on one or both of the surfaces of the base member to constitute a plate-like fuse element as a whole. Alternatively, a rod-like base member can be used, and the covering member can be provided to cover the outer circumferential surface of the base member to constitute a rod-like fuse element as a whole.

The fuse element of the present invention is heated to a predetermined heating temperature (hereinafter also referred to as a “heating peak temperature”) to be bonded to the protection device. The base member is made of a first fusible metal having a melting point higher than the heating peak temperature. The covering member is made of a second fusible metal having a melting point lower than the heating peak temperature. When bonding with the protection device, first, the fuse element or the fuse element and the protection device are heated with the covering member of the fuse element being in contact with a bonded part of the protection device, the second fusible metal constituting the covering member is melted to bond the fuse element and the protection device. The heating peak temperature is preferably more than or equal to 183° C. and less than 280° C., and more preferably more than or equal to 219° C. and less than 227° C.

Suitable examples of metal that may be used as the first fusible metal include 205n-80Au alloy, 55Sn-45Sb alloy, and Pb—Sn alloy containing more than or equal to 80 mass % of Pb although it depends on the heating peak temperature. The number in front of each chemical symbol represents the blending ratio of alloy (wt %). Suitable examples of metal that may be used as the second fusible metal include a Sn—Ag alloy, a Sn—Bi alloy, a Sn—Cu alloy, a Sn—Zn alloy, a Sn—Sb alloy, a Sn—Ag—Bi alloy, a Sn—Ag—Cu alloy, a Sn—Ag—In alloy, a Sn—Zn—Al alloy, a Sn—Zn—Bi alloy, or an alloy further containing at least one metallic element of Au, Ni, Ge, and Ga in addition to these alloys.

A method of providing the covering member on the surface of the base member is not particularly limited as long as the covering member adheres to the surface of the base member. For example, the covering member can adhere to the surface of the base member by a method such as cladding, plating, fused coating, pressure bonding, or adhesion with a fusible resin such as rosin. The base member may be either a single layer or multiple layers, but is preferably made of a single layer. The covering member may be either a single layer or multiple layers, but is preferably made of a single layer.

The fuse element of the present invention is used in the state provided for a circuit protection device to be incorporated into an external circuit. If a malfunction occurs in the external circuit to raise the temperature of the external circuit, the fuse element is fused resulting from the malfunction temperature to emergently stop the operation of the external circuit. The temperature at which the fuse element is fused can be adjusted by appropriately selecting the first fusible metal, and can be set at more than or equal to 247° C. and less than or equal to 296° C., for example.

### First Embodiment

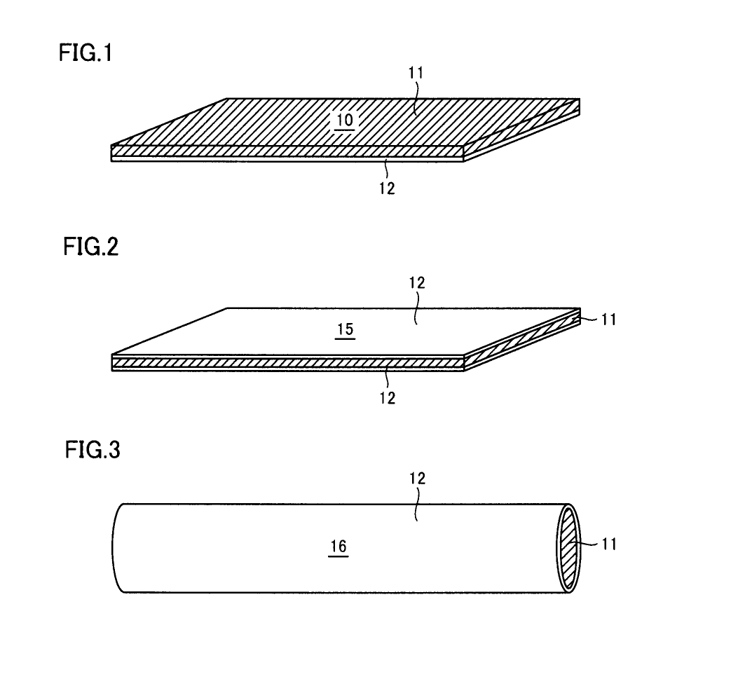

FIG. 1 is a perspective view schematically showing a fuse element for a protection device of a first embodiment. As shown in FIG. 1, a fuse element 10 is a plate-like member, and is composed of a plate-like base member 11 and a covering member 12 covering one of the surfaces of base member 11. The thickness of fuse element 10 is preferably 64 μm to 300 μm, and more preferably 80 μm to 110 μm, in terms of reduction in size and thickness of a circuit protection device on which it is to be mounted.

The thickness of covering member 12 in fuse element 10 is preferably more than or equal to 1% and less than or equal to 20% of the thickness of fuse element 10, and more preferably more than or equal to 5% and less than or equal to 15%. If the thickness of covering member 12 exceeds 20%, fuse element 10 may vary in operating temperature and internal resistance value, and stripping is likely to occur after bonding the fuse element to the protection device because of the excessively remaining second fusible metal constituting covering member 12, which may exercise an adverse effect on reliability of the circuit protection device. If the thickness of covering member 12 is less than 1%, it may be difficult to sufficiently bond the fuse element to the protection device. The thickness of covering member 12 can be set at 5 μm to 15 μm, for example, although it depends on the entire thickness of fuse element 10.

### Second Embodiment

FIG. 2 is a perspective view schematically showing a fuse element for a protection device of a second embodiment. As shown in FIG. 2, a fuse element 15 is a plate-like member, and is composed of plate-like base member 11 and covering member 12 covering both surfaces of base member 11. The thickness of fuse element 15 is preferably 64 μm to 300 μm, and more preferably 80 μm to 110 μm, in terms of reduction in size and thickness of the circuit protection device on which it is to be mounted. For reasons similar to those of the first embodiment, the thickness of covering member 12 in fuse element 15 is preferably more than or equal to 1% and less than or equal to 20% of the thickness of fuse element 15, and more preferably more than or equal to 5% and less than or equal to 15%.

By providing covering member 12 on each of the upper and lower sides of base member 11, fuse element 15 has no directivity of front and rear, which can prevent erroneous mounting of the fuse element in the step of assembling the circuit protection device.

### Third Embodiment

FIG. 3 is a perspective view schematically showing a fuse element for a protection device of a third embodiment. As shown in FIG. 3, fuse element 16 is a rod-like member, and is composed of rod-like base member 11 and covering member 12 covering the outer circumferential surface of base member 11. The diameter of fuse element 30 is preferably 64 μm to 300 μm, and more preferably 80 μm to 110 μm, in terms of reduction in size and thickness of a circuit protection device on which it is to be mounted. For reasons similar to those of the first embodiment, the thickness of covering member 12 in fuse element 30 is preferably more than or equal to 1% and less than or equal to 20% of the diameter of fuse element 30, and more preferably more than or equal to 5% and less than or equal to 15%.

Although not particularly shown, rod-like fuse element 16 may further be rolled into the form of a plate for usage. Even if the diameter of the fuse element exceeds 300 μm, rod-like fuse element 30 can be molded such that the thickness of covering member 12 becomes more than or equal to 1% and less than or equal to 20% of the diameter of the fuse element, and this can be rolled into the form of a plate having a thickness of less than or equal to 300 μm for usage.

### Circuit Protection Device

### Fourth Embodiment

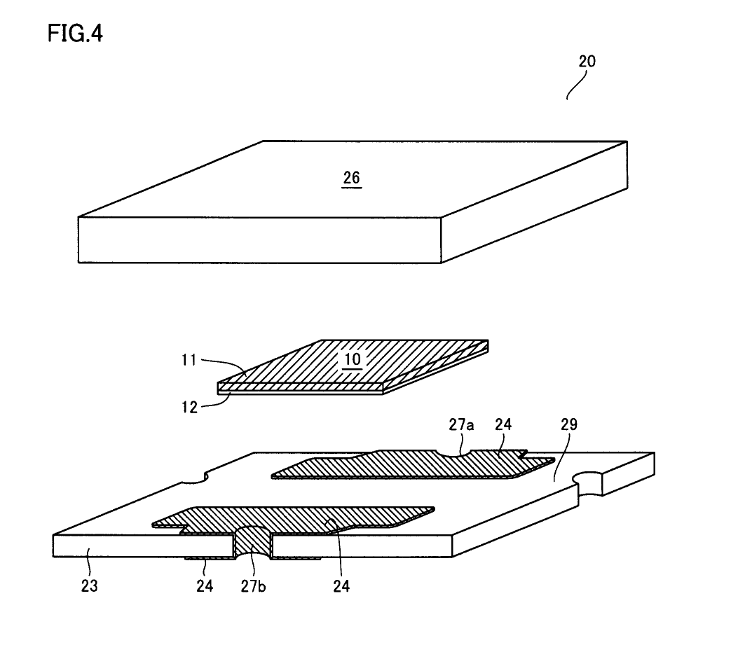

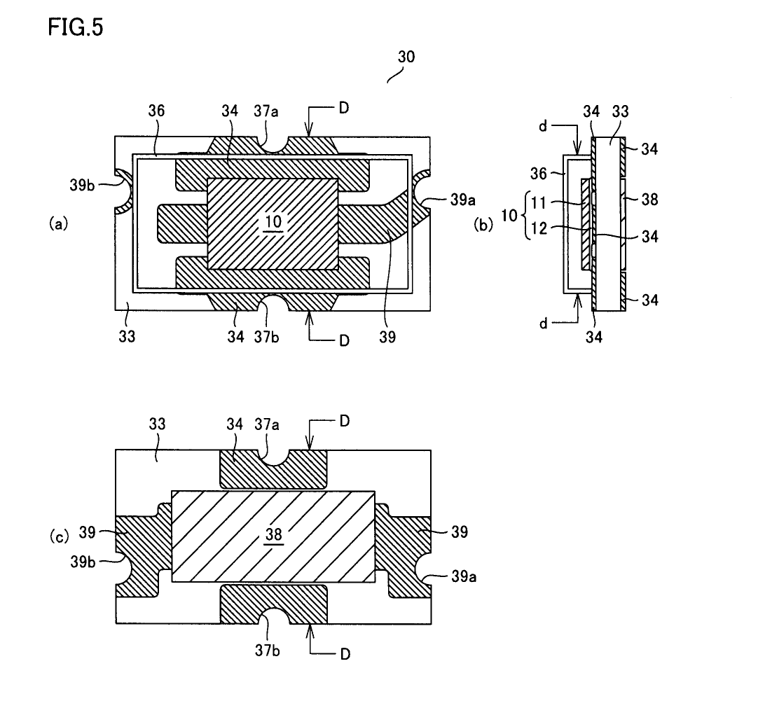

FIG. 4 is an exploded perspective view showing a structure of a circuit protection device of a fourth embodiment. A circuit protection device 20 shown in FIG. 4 includes an insulating substrate 23, a pattern electrode 24 provided on a surface of insulating substrate 23, fuse element 10 bonded to pattern electrode 24 and electrically connected to pattern electrode 24, and a cap-like cover member 26 covering fuse element 10. The case where fuse element 10 of the first embodiment shown in FIG. 1 is used as fuse element 10 is shown, however, this is not a limitation. Fuse element 15 or 16 of the second or third embodiment shown in FIG. 2 or 3 can also be used.

Insulating substrate 23 is implemented by a heat resistant insulating substrate, such as a glass epoxy substrate, a BT (Bismalemide Triazine) substrate, a Teflon (registered trademark) substrate, a ceramics substrate, or a glass substrate. The thickness of insulating substrate 23 is more than or equal to 0.20 mm and less than or equal to 0.40 mm, for example.

Pattern electrode 24 is formed in any pattern on the surface of insulating substrate 23, and is connected to an external circuit through terminals 27a and 27b provided in half through-holes on the side surfaces of insulating substrate 23. Pattern electrode 24 is intended to flow electric current to fuse element 10, and is formed to be electrically open when fuse element 10 is fused. Pattern electrode 24 is made of, for example, a metallic material such as tungsten, molybdenum, nickel, copper, silver, gold, or aluminum, or alloy thereof, or a composite material obtained by blending some of these materials, or composite layers of those materials.

Cap-like cover member 26 only needs to cover insulating substrate 23 and fuse element 25 from above to keep desired space, and is not limited in shape and material, but is made of, for example, a dome-like resin film material, a plastic material, a ceramic material, or the like.

The circuit protection device of the present invention is used in the state incorporated in an external circuit. If a malfunction occurs in the external circuit to raise the temperature of the external circuit, the fuse element is fused resulting from the malfunction temperature to emergently stop the operation of the external circuit.

A method for manufacturing circuit protection device 20 includes a preparation step (St10) of preparing insulating substrate 23 with pattern electrode 24 provided on a surface thereof as well as fuse element 10 having base member 11 and covering member 12 covering one of the surfaces of the base member, a bonding step (St20) of heating fuse element 10 to a heating temperature of more than or equal to 183° C. and less than 280° C. with covering member 12 of fuse element 10 being in contact with pattern electrode 24 to electrically connect fuse element 10 to pattern electrode 24, and a packaging step (St30) of covering fuse element 24 with cap-like cover member 26 for packaging.

In the bonding step (St20), fuse element 10 is heated to a temperature higher than a melting point of the second fusible metal constituting covering member 12 of fuse element 10. Covering member 12 of fuse element 10 is thus melted to be bonded to pattern electrode 24. Heating means applied in the bonding step (St20) is not particularly limited, but any method or apparatus may be used as long as it is means that can heat fuse element 10 mounted on insulating substrate 23 so as to come into contact with pattern electrode 24 to a heating peak temperature. For example, heating through use of a high-temperature batch furnace, heating through use of a hot plate, heating through use of a reflow furnace, or the like can be suitably utilized.

In the bonding step (St20) of the method for manufacturing circuit protection device 20, it is preferable that an oxide film and the like on the bonded surfaces of pattern electrode 24 and fuse element 10 to be bonded be removed, and the bonded surfaces be activated. As a method for activating the bonded surfaces in this manner, a bonding flux applying step (St11) for applying flux for bonding to the bonded surface of pattern electrode 24 to be bonded to fuse element 10 may be provided prior to the bonding step (St20), or the bonded surface of fuse element 10 to be bonded to pattern electrode 24 may be previously impregnated with flux for bonding. Alternatively, by using a reflow furnace in which an activation gas is used, such as a hydrogen reduction furnace or a formic acid reduction furnace, for the heating means in the bonding step (St20), not only heating but also removal of an oxide film and the like on a metal surface and activation may be carried out simultaneously. The flux for bonding has an effect of removing an oxide film on a metal surface and promoting bonding. The flux for bonding is a material having excellent thermal conductivity, and is made of, for example, a material obtained by dissolving pine resin in turpentine oil, or a material such as zinc chloride.

The method for manufacturing circuit protection device 20 preferably includes a fusing flux applying step (St21) for applying flux for fusing to fuse element 10 after the bonding step (St20) and prior to the packaging step (St30). The flux for fusing facilitates transfer of the temperature around fuse element 10 to fuse element 10 and contributes to improvement in fusing speed. The flux for fusing is a material having excellent thermal conductivity, and is made of, for example, a material obtained by dissolving pine resin in turpentine oil, or a material such as zinc chloride.

### Fifth Embodiment

FIG. 5 shows a structure of a circuit protection device of a fifth embodiment. FIG. 5(a) shows a schematic view of an upper surface. FIG. 5(b) shows a longitudinal section. FIG. 5(c) shows a schematic view of a lower surface. FIG. 5(a) corresponds to a cross sectional view taken along the line d-d in FIG. 5(b). FIG. 5(b) corresponds to a cross sectional view taken along the line D-D in FIG. 5(a) or (c). Circuit protection device 30 shown in FIG. 5 includes an insulating substrate 33, a pattern electrode 34 provided on a surface of insulating substrate 33, fuse element 10 bonded to pattern electrode 34 and electrically connected to pattern electrode 34, and a cap-like cover member 36 covering fuse element 10. In addition, provided on the rear surface of insulating substrate 33 are a conductive pattern 39 and a heating resistor 38 to be electrically connected to conductive pattern 39. The case where fuse element 10 of the first embodiment shown in FIG. 1 is used as fuse element 10 is shown, however, this is not a limitation, but fuse element 15 or 16 of the second or third embodiment shown in FIG. 2 or 3 can also be used.

Pattern electrode 34 is formed in any pattern on the surface of insulating substrate 33, and is connected to an external circuit through terminals 37a and 37b provided in half through-holes on the side surfaces of insulating substrate 33. Pattern electrode 34 is intended to flow electric current to fuse element 10, and is formed to be electrically open when fuse element 10 is fused. Heating resistor 38 is connected to a malfunction detector incorporated in the external circuit through terminals 39a and 39b provided in the half through-holes. When the malfunction detector detects a malfunction of the external circuit, electric current is applied to heating resistor 38 through terminals 39a, 39b and conductive pattern 39 to raise the temperature of heating resistor 38. As a result, fuse element 10 can be fused resulting from the temperature rise of heating resistor 38. It is noted that conductive pattern 39 is also provided on the surface of insulating substrate 33 to be in contact with fuse element 10, and can conduct the temperature of heating resistor 38 to fuse element 10 with high efficiency. In the present embodiment, the structure is adopted in which pattern electrodes 34 or conductive patterns 39 formed on the front and rear surfaces are electrically connected through terminals 37a, 37b, 39a, and 39b provided in the half through-holes, however, conductor through-holes extending through insulating substrate 33 or surface wiring accomplished by a flat electrode pattern may be adopted instead of the half through-holes.

Heating resistor 38 is made of, for example, a metallic material such as tungsten, silver, palladium, ruthenium, lead, boron, or aluminum, or alloy or oxide thereof, or a composite material obtained by blending a plurality of materials, or composite layers of those materials. An insulating coating may be applied to the surface of heating resistor 38.

Circuit protection device 30 of the fifth embodiment is merely different from circuit protection device 20 of the fourth embodiment in that heating resistor 38 is provided on the rear surface of the insulating substrate. The components other than heating resistor 38 and the manufacturing method are as those described in the first embodiment.

### Sixth Embodiment

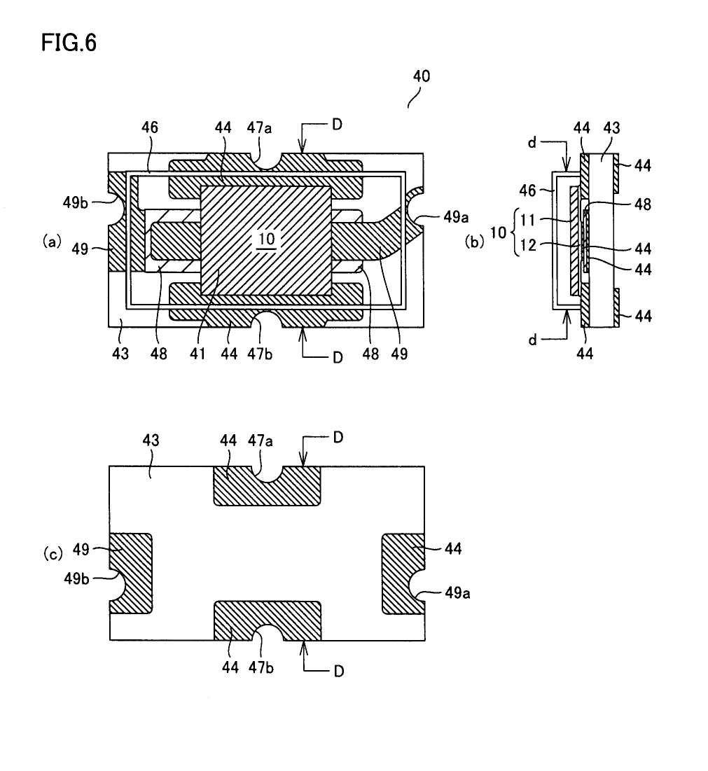

FIG. 6 shows a structure of a circuit protection device of a sixth embodiment. FIG. 6(a) shows a schematic view of an upper surface. FIG. 6(b) shows a longitudinal section. FIG. 6(c) shows a schematic view of a lower surface. FIG. 6(a) corresponds to a cross sectional view taken along the line d-d in FIG. 6(b). FIG. 6(b) corresponds to a cross sectional view taken along the line D-D in FIG. 6(a) or (c). A circuit protection device 40 shown in FIG. 6 includes an insulating substrate 43, a pattern electrode 44 provided on a surface of insulating substrate 43, fuse element 10 bonded to pattern electrode 44 and electrically connected to pattern electrode 44, and a cap-like cover member 46 covering fuse element 10. In addition, provided on the lower side of insulating substrate 43 are a conductive pattern 49 and a heating resistor 48 to be electrically connected to conductive pattern 49. When bonded to pattern electrode 44, fuse element 10 is brought into contact with heating resistor 48. FIG. 6 shows the case where fuse element 10 of the first embodiment shown in FIG. 1 is used as fuse element 10, however, this is not a limitation. Fuse element 15 or 16 of the second or third embodiment shown in FIG. 2 or 3 can also be used.

Pattern electrode 44 is formed in any pattern on the surface of insulating substrate 43, and is connected to an external circuit through terminals 47a and 47b provided in half through-holes formed on the side surfaces of insulating substrate 43. Pattern electrode 44 is intended to flow electric current to fuse element 10, and is formed to be electrically open when fuse element 10 is fused. Heating resistor 48 is connected to a malfunction detector incorporated in the external circuit through terminals 49a and 49b provided in the half through-holes. When the malfunction detector detects a malfunction of the external circuit, electric current is applied to heating resistor 48 through terminals 49a, 49b and conductive pattern 49 to raise the temperature of heating resistor 48. As a result, fuse element 10 can be fused resulting from the temperature rise of heating resistor 48.

Circuit protection device 40 of the sixth embodiment is merely different from circuit protection device 30 of the fifth embodiment in that heating resistor 48 is provided on the front surface of the insulating substrate.

### EXAMPLE

### Example 1

### Fuse Element for Protection Device

Fuse element 10 for protection device of Example 1 has the structure shown in FIG. 1, and is made of a composite metallic material in which 90-μm-thick plate-like base member 11 made of a 87Pb-13Sn alloy (first fusible metal) having a melting point of 280° C. to 290° C. and 10-μm-thick covering member 12 made of a Sn-3Ag-0.5Cu alloy (second fusible metal) having a melting point of 220° C. are bonded by cladding.

### Example 2

### Fuse Element for Protection Device

Fuse element 15 for protection device of Example 2 has the structure shown in FIG. 2, and is made of a tirlayer composite metallic material in which 5-μm-thick covering member 12 made of a Sn-0.7Cu alloy (second fusible metal) having a melting point of 227° C. is provided by electroplating on each of the upper and lower surfaces of 90-μm-thick plate-like base member 11 made of a 87Pb-13Sn alloy (first fusible metal) having a melting point of 280° C. to 290° C.

### Example 3

### Fuse Element for Protection Device

Fuse element 16 for protection device of Example 3 has the structure shown in FIG. 3, and is made of a composite metallic material in which 10-μm-thick covering member 12 made of a Sn-3.5Ag alloy (second fusible metal) having a melting point of 221° C. is pressure bonded on the outer circumferential surface of 280-μm-diameter rod-like base member 11 made of a 87Pb-13Sn alloy (first fusible metal) having a melting point of 280° C. to 290° C. by covering and wire drawing.

### Examples 4-1, 4-2 and 4-3

### Circuit Protection Device

For circuit protection devices of Examples 4-1, 4-2 and 4-3, the fuse elements for protection device of Examples 1 to 3 were respectively used instead of fuse element 10 of circuit protection device 20 shown in FIG. 4 to be bonded to pattern electrode 24, thereby constituting the circuit protection devices. In circuit protection device 20 shown in FIG. 4, an insulating substrate of alumina ceramics was used as insulating substrate 23, and an Ag alloy pattern electrode was used as pattern electrode 24.

Flux for bonding was previously applied to pattern electrode 24, and the fuse element was mounted to be in contact therewith, and was passed through a reflow furnace whose temperature profile had been set such that the retention time was 45 seconds at a remaining heat temperature of 180° C. to 190° C. and the retention time was 30 seconds at more than or equal to 225° C. with a heating peak temperature of 235° C. to melt the second fusible metal constituting covering member 12, thereby collectively bonding fuse elements to pattern electrode 24. Thereafter, flux for fusing was applied to the bonded fuse elements, and the fuse elements on insulating substrate 23 were covered with cap-like cover member 26 made of heat resistant plastics to fix cap-like cover member 26 and insulating substrate 23 with epoxy resin, thereby obtaining the circuit protection devices of Examples 4-1, 4-2 and 4-3.

### Examples 5-1, 5-2 and 5-3

### Circuit Protection Device

For circuit protection devices of Examples 5-1, 5-2 and 5-3, the fuse elements for protection device of Examples 1 to 3 were respectively used instead of fuse element 10 of circuit protection device 30 shown in FIG. 5 to be bonded to pattern electrode 34, thereby constituting the circuit protection devices. In circuit protection device 30 shown in FIG. 5, an insulating substrate of alumina ceramics was used as insulating substrate 33, and an Ag alloy pattern electrode was used as pattern electrode 34. Heating resistor 38 was provided on the rear surface of insulating substrate 33. The surface of heating resistor 38 was overglazed with a glass material.

Flux for bonding was previously applied to pattern electrode 34, and the fuse element was mounted to be in contact therewith, and was passed through a reflow furnace whose temperature profile had been set such that the retention time was 60 seconds at a remaining heat temperature of 100° C. to 180° C. and the retention time was 5 seconds at more than or equal to 220° C. with a heating peak temperature of 230° C. to melt the second fusible metal constituting covering member 12, thereby collectively bonding fuse elements to pattern electrode 34. Thereafter, flux for fusing was applied to the bonded fuse elements, and the fuse elements on insulating substrate 33 were covered with cap-like cover member 36 made of liquid crystal polymer to fix cap-like cover member 36 and insulating substrate 33 with epoxy resin, thereby obtaining the circuit protection devices of Examples 5-1, 5-2 and 5-3.

### Example 6-1, 6-2 and 6-3

### Circuit Protection Device

For circuit protection devices of Examples 6-1, 6-2 and 6-3, the fuse elements for protection device of Examples 1 to 3 were respectively used instead of fuse element 10 of circuit protection device 40 shown in FIG. 6 to be bonded to pattern electrode 44, thereby constituting the circuit protection devices. In circuit protection device 40 shown in FIG. 6, an insulating substrate of alumina ceramics was used as insulating substrate 43, and an Ag alloy pattern electrode was used as pattern electrode 44. Heating resistor 48 was previously provided on the front surface of insulating substrate 43. The surface of heating resistor 38 was overglazed with a glass material.

Flux for bonding was previously applied to pattern electrode 434, and the fuse element was mounted to be in contact therewith, and was passed through a reflow furnace whose temperature profile had been set such that the retention time was 60 seconds at a remaining heat temperature of 100° C. to 180° C. and the retention time was 5 seconds at more than or equal to 220° C. with a heating peak temperature of 230° C. to melt the second fusible metal constituting covering member 12, thereby collectively bonding fuse elements to pattern electrode 44. Thereafter, flux for fusing was applied to the bonded fuse elements, and the fuse elements on insulating substrate 43 were covered with cap-like cover member 46 made of liquid crystal polymer to fix cap-like cover member 46 and insulating substrate 43 with epoxy resin, thereby obtaining the circuit protection devices of Examples 6-1, 6-2 and 6-3.

### Comparative Example 1

### Circuit Protection Device

For a circuit protection device of Comparative Example 1, a fuse element made only of a 100-μm-thick 87Pb-13Sn alloy plate was used instead of fuse element 10 of circuit protection device 30 shown in FIG. 5 to be bonded to pattern electrode 34, thereby forming the circuit protection device. It is noted that bonding to pattern electrode 34 was carried out with a laser welder.

[Evaluation]

Three samples, No. 1 to No. 3 were prepared for each of the circuit protection device of Example 5-1 and the circuit protection device of Comparative Example 1, and the following evaluation was made. Table 1 shows the result of evaluation. It is noted that a 2.0 mm×2.4 mm fuse element was used for each of the circuit protection device of Example 5-1 and the circuit protection device of Comparative Example 1.

(Evaluation of Internal Resistance Value)

At a room temperature of 25° C., electric current was flown across terminals 37a and 37b of the circuit protection device to measure an internal resistance value of the fuse element.

(Evaluation of Resistance Value of Heating Resistor)

At a room temperature of 25° C., electric current was flown across terminals 39a and 39b of the circuit protection device to measure a resistance value of the heating resistor.

(Evaluation of Operation Time)

At a room temperature of 25° C., 10 W was applied across terminal 39b and 37a, 37b of the circuit protection device to measure the time until the fuse element operates.

TABLE 1

| | | Internal | Heat | Operation |
|---|---|---|---|---|
| | Sample | Resistance | Resistance | Time |
| | No. | (mΩ) | (Ω) | (sec) |
| Example 5-1 | 1 | 2.6 | 7.7 | 2.1 |
| | 2 | 2.3 | 7.3 | 2.6 |
| | 3 | 2.4 | 7.4 | 2.3 |
| Comparative | 1 | 5.1 | 7.3 | 3.7 |
| Example 1 | 2 | 5.8 | 7.4 | 4.1 |
| | 3 | 5.5 | 7.6 | 3.9 |

The result shown in Table 1 reveals that the circuit protection device of Example 5-1 has a small internal resistance value and has reduced power loss as compared with Comparative Example 1. It is also seen that the circuit protection device of Example 5-1 has a shortened operation time and improved operation performance as compared with Comparative Example 1. This is interpreted because thermal conductivity is improved by increasing the bonding area.

### INDUSTRIAL APPLICABILITY

The fuse element for a protection device of the present invention can be incorporated into and mounted on a circuit protection device by overall heat melting such as reflow. Furthermore, the circuit protection device of the present invention including the fuse element can be solder mounted again on an electric circuit board by reflow soldering together with other surface mount devices to be utilized for a protection device for a secondary battery, such as a battery pack.

### REFERENCE SIGNS LIST

10, 15, 16 fuse element for protection device; 11 base member; 12 covering member; 20, 30, 40 circuit protection device; 23, 33, 43 insulating substrate; 24, 34, 44 pattern electrode; 26, 36, 46 cap-like cover member; 29, 39, 49 conductive pattern; 38, 48 heating resistor.

1. A fuse element for a protection device having a base member and a covering member covering an entire surface of said base member at a bonded part with the protection device and to be heated to a predetermined heating temperature to be bonded to the protection device,
said fuse element being one of a plate-like member in which said covering member has a thickness of more than or equal to 1% and less than or equal to 20% of a thickness of said plate-like member, and a rod-like member in which said covering member has a thickness of more than or equal to 1% and less than or equal to 20% of a diameter of said rod-like member,
said base member being made of a first fusible metal having a melting point higher than said heating temperature,
said covering member being made of a second fusible metal having a melting point lower than said heating temperature.

2. The fuse element for a protection device according to claim 1, wherein said heating temperature is more than or equal to 183° C. and less than 280° C.

3. The fuse element for a protection device according to claim 1, wherein a contact surface coming into contact with said protection device during said bonding contains flux for bonding.

4. The fuse element for a protection device according to claim 1, wherein said first fusible metal is one of a 20Sn-80Au alloy, a 55Sn-45Sb alloy, and a Pb—Sn alloy containing more than or equal to 80 mass % of Pb.

5. The fuse element for a protection device according to, claim 1, wherein said second fusible metal is one of a Sn—Ag alloy, a Sn—Bi alloy, a Sn—Cu alloy, a Sn—Zn alloy, a Sn—Sb alloy, a Sn—Ag—Bi alloy, a Sn—Ag—Cu alloy, a Sn—Ag—In alloy, a Sn—Zn—Al alloy, a Sn—Zn—Bi alloy, and an alloy further containing at least one metallic element of Au, Ni, Ge, and Ga in addition to these alloys.

6. (canceled)

7. A circuit protection device comprising an insulating substrate, a pattern electrode provided on a surface of said insulating substrate, and a fuse element that has been heated to a predetermined heating temperature to be bonded to said pattern electrode and to be electrically connected to said pattern electrode,
said fuse element having a base member and a covering member covering an entire surface of said base member at a bonded part with said pattern electrode,
said base member being made of a first fusible metal having a melting point higher than said heating temperature,
said fuse element being one of a plate-like member in which said covering member has a thickness of more than or equal to 1% and less than or equal to 20% of a thickness of said plate-like member, and a rod-like member in which said covering member has a thickness of more than or equal to 1% and less than or equal to 20% of a diameter of said rod-like member,
said covering member being made of a second fusible metal having a melting point lower than said heating temperature,
said heating temperature is more than or equal to 183° C. and less than 280° C.

8. The circuit protection device according to claim 7, further comprising a heating resistor provided on said insulating substrate.

9. The circuit protection device according to claim 7, wherein said first fusible metal is one of a 20Sn-80Au alloy, a 55Sn-45Sb alloy, and a Pb—Sn alloy containing more than or equal to 80 mass % of Pb.

10. The circuit protection device according to claim 7, wherein said second fusible metal is one of a Sn—Ag alloy, a Sn—Bi alloy, a Sn—Cu alloy, a Sn—Zn alloy, a Sn—Sb alloy, a Sn—Ag—Bi alloy, a Sn—Ag—Cu alloy, a Sn—Ag—In alloy, a Sn—Zn—Al alloy, a Sn—Zn—Bi alloy, and an alloy further containing at least one metallic element of Au, Ni, Ge, and Ga in addition to these alloys.

11. (canceled)

12. A method for manufacturing a circuit protection device, comprising:
a preparation step of preparing an insulating substrate with a pattern electrode provided on a surface as well as a fuse element having a base member and a covering member covering an entire surface of said base member at a bonded part with said pattern electrode;
a bonding step of heating said fuse element to a heating temperature of more than or equal to 183° C. and less than 280° C. with said covering member of said fuse element being in contact with said pattern electrode to bond and electrically connect said fuse element to said pattern electrode;
a fusing flux applying step of applying fusing flux for operation to said fuse element; and
a packaging step of covering said fuse element with a cap-like cover member for packaging,
in said fuse element, said covering member covering said entire surface of said base member at said bonded part with said pattern electrode, said fuse element being one of a plate-like member in which said covering member has a thickness of more than or equal to 1% and less than or equal to 20% of a thickness of said plate-like member, and a rod-like member in which said covering member has a thickness of more than or equal to 1% and less than or equal to 20% of a diameter of said rod-like member, said base member being made of a first fusible metal having a melting point higher than the heating temperature in said bonding step, and said covering member being made of a second fusible metal having a melting point lower than said heating temperature.

13. The method for manufacturing a circuit protection device according to claim 12, having, prior to said bonding step, a bonding flux applying step of applying flux for bonding to said pattern electrode.

14. The method for manufacturing a circuit protection device according to claim 12, wherein, in said bonding step, one of a hydrogen reduction furnace and a formic acid reduction furnace is used as heating means to remove oxide films on surfaces of said pattern electrode and said fuse element along with heating, thereby activating bonded surfaces.

15. The method for manufacturing a circuit protection device according to claim 12, wherein said fuse element contains flux for bonding in a contact surface to be in contact with said pattern electrode.
